(19) United States
(12) Patent Application Publication
(10) Pub. No.: US 2011/0090197 A1
(43) Pub. Date: Apr. 21, 2011

(54) PLASMA DISPLAY AND DRIVING APPARATUS THEREOF

(76) Inventor: Yoo-Jin Song, Yongin-si (KR)

(21) Appl. No.: 12/856,559

(22) Filed: Aug. 13, 2010

(30) Foreign Application Priority Data
Oct. 16, 2009 (KR) 10-2009-0098889

(51) Int. Cl. G09G 3/28; G09G 5/00

(52) U.S. Cl. 345/209; 345/208; 345/60

(57) ABSTRACT

A plasma display includes a panel capacitor formed by a first electrode and a second electrode for sustain discharging in a sustain period. A driving apparatus of such plasma display includes a switching circuit unit, and a transformer including a primary coil and a secondary coil. The switching circuit unit generates a square wave voltage using an input voltage of an input source so that a voltage of two terminals of the panel capacitor alternately has a positive voltage and a negative voltage. The primary coil is connected between two output terminals of the switching circuit unit, and the secondary coil is connected between two terminals of the panel capacitor.

### CROSS-REFERENCE TO RELATED APPLICATION

This application claims priority to and the benefit of Korean Patent Application No. 10-2009-0098889 filed in the Korean Intellectual Property Office on Oct. 16, 2009, the entire contents of which are incorporated herein by reference.

### BACKGROUND

1. Field

The described technology relates generally to a plasma display and a driving apparatus thereof. More particularly, the described technology relates generally to a sustain discharge circuit for generating a sustain discharge between two electrodes in a sustain period.

2. Description of the Related Art

A plasma display device is a display device using a plasma display panel for displaying characters or images by using plasma generated according to gas discharge. Such a plasma display panel includes a plurality of discharge cells arranged in a matrix format.

The plasma display device drives a panel capacitor by dividing a frame into a plurality of subfields each having a luminance weight value, and displays a grayscale by a combination of weight values of subfields in which a display operation is generated among the plurality of subfields. During an address period of each subfield, a light emitting cell and a non-light emitting cell are selected. During a sustain period of each subfield, the light emitting cell is sustain discharged so that images are displayed.

For operation of the sustain period, during the sustain period, a sustain pulse alternately having a high level voltage and a low level voltage is applied to a scan electrode and a sustain electrode while having opposite phases.

Thus, the plasma display device includes a sustain discharge circuit for applying the sustain pulse to the scan electrode and a sustain discharge circuit for applying the sustain pulse to the sustain electrode, and a power supply for generating a high voltage and a low voltage in order to supply the high voltage and the low voltage to the sustain discharge circuit. Such power supply changes an input AC voltage into a DC voltage and then generates the high voltage and the low voltage using a plurality of DC/DC converters, and transmits the high voltage and the low voltage to the sustain discharge circuit.

A voltage drop may be generated when the high voltage and the low voltage are transmitted to the sustain discharge circuit. Thus, the sustain discharge may not be appropriately generated.

Further, since the plasma display device includes the sustain discharge circuits for applying the scan electrode and the sustain electrode, respectively, the cost of the plasma display device may be increased.

The above information disclosed in this Background section is only for enhancement of understanding of the background of the described technology and therefore it may contain information that does not form the prior art that is already known in this country to a person of ordinary skill in the art.

### SUMMARY

According to an aspect of the present invention, the described technology has been made in an effort to provide a plasma display that can reduce a voltage drop and the cost of the plasma display, and a driving apparatus thereof.

In an exemplary embodiment, a plasma display is disclosed. According to an exemplary embodiment, the plasma display includes a panel capacitor formed by first and second electrodes for performing a sustain discharge, and a driver. The driver drives the panel capacitor so that a voltage between a first terminal of the panel capacitor and a second terminal of the panel capacitor alternately has a positive first voltage and a negative second voltage. The driver includes a switching circuit unit, and a transformer. The switching circuit unit includes at least one switch element connected to an input source for supplying an input voltage, a first output terminal, and a second output terminal. Further, the switching circuit unit operates so that a voltage between the first output terminal and the second output terminal becomes a square wave voltage using the at least one switch element. The transformer includes a primary coil having a first terminal and a second terminal connected to the first and second output terminals of the switching circuit unit, respectively, and a secondary coil directly connected between the first and second terminals of the panel capacitor.

Another exemplary embodiment includes a driving apparatus of a plasma display including a panel capacitor formed by a first electrode and a second electrode for sustain discharging in a sustain period.

According to another embodiment, the driving apparatus includes a switching circuit unit and a transformer. The switching circuit unit includes at least one switch element connected to an input source for supplying an input voltage, a first output terminal, and a second output terminal. Further, the switching circuit unit operates so that a voltage between the first output terminal and the second output terminal becomes a square wave voltage using the at least one switch element. The transformer includes a primary coil having a first terminal and a second terminal connected to the first and second output terminals of the switching circuit unit, respectively, and a secondary coil connected between first and second terminals of the panel capacitor. The transformer forms a current path from a first terminal of the panel capacitor to a second terminal of the panel capacitor and a current path from the second terminal of the panel capacitor to the first terminal of the panel capacitor in response to the turning on and turning off of the at least one switch.

According to an exemplary embodiment, since the plasma display may generate the sustain discharge between the two electrodes using one sustain discharge circuit during the sustain period, the cost of the plasma display may be reduced. Further, since a sustain discharge circuit and a DC/DC converter are integrated, the voltage drop generated when the DC/DC converter transmits a voltage to the sustain discharge circuit may be reduced.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a drawing showing a plasma display according to an exemplary embodiment;

FIG. 2 is a drawing showing a voltage difference between a scan electrode and a sustain electrode;

FIG. 3 is a drawing showing a sustain discharge circuit according to an exemplary embodiment; and

FIG. 4 is a drawing showing a waveform for describing operation of the sustain discharge circuit shown FIG. 3.

### DETAILED DESCRIPTION

In the following detailed description, certain exemplary embodiments have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. Throughout this specification and the claims that follow, when it is described that an element is “coupled” to another element, the element may be “directly coupled” to the other element or “coupled” to the other element through a third element.

The plasma display and a driving apparatus thereof according to the exemplary embodiment will now be described in detail.

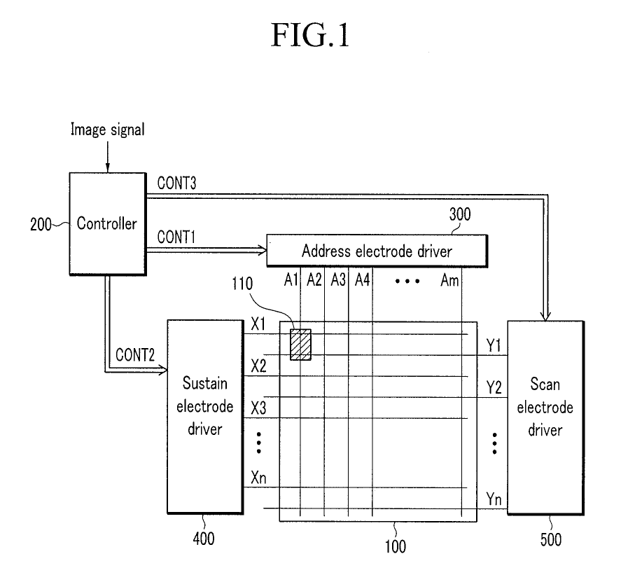

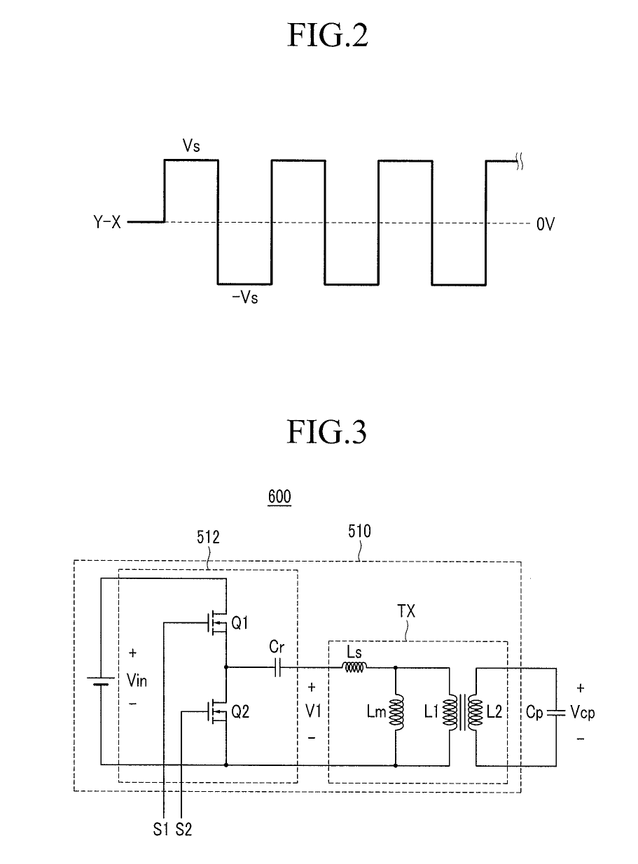

FIG. 1 is a drawing showing a plasma display according to an exemplary embodiment, and FIG. 2 is a drawing showing a voltage difference between a scan electrode and a sustain electrode.

As shown in FIG. 1, a plasma display device according to an exemplary embodiment includes a plasma display panel 100, a controller 200, an address electrode driver 300, a sustain electrode driver 400, and a scan electrode driver 500.

The plasma display panel 100 includes a plurality of address electrodes A1-Am (referred to as “A electrodes” hereinafter) extending in a column direction, and a plurality of sustain electrodes X1-Xn (referred to as “X electrodes” hereinafter) and a plurality of scan electrodes Y1-Yn (referred to as “Y electrodes” hereinafter) extending in a row direction, in pairs.

In general, the X electrodes X1-Xn are formed to correspond to the respective Y electrodes Y1-Yn, and the X electrodes X1-Xn and the Y electrodes Y1-Yn perform a display operation during a sustain period in order to display an image.

The Y electrodes Y1-Yn and the X electrodes X1-Xn are disposed to cross the A electrodes A1-Am. Discharge spaces at each crossing area of the A electrodes A1˜Am and the X and Y electrodes X1˜Xn and Y1˜Yn form discharge cells 110.

The structure of the PDP 100 is one example, and a panel with a different structure to which driving waveforms described herein can be applied can also be utilized.

The controller 200 drives a frame by dividing the frame into a plurality of subfields each having a weight value. Each subfield includes an address period, and a sustain period. The controller 200 receives an image signal of one frame from the outside of the controller 200 and generates an A electrode driving control signal CONT1, an X electrode driving control signal CONT2, and a Y electrode driving control signal CONT3, and outputs the A electrode driving control signal CONT1, the X electrode driving control signal CONT2, and the Y electrode driving control signal CONT3 to the address, sustain, and scan electrode drivers 300, 400, and 500, respectively.

The address electrode driver 300 receives the A electrode driving control signal CONT1 from the controller 200 and applies a driving voltage to the A electrodes A1-Am.

The sustain electrode driver 400 receives the X electrode driving control signal CONT2 from the controller 200 and applies a driving voltage to the X electrodes X1-Xn.

The scan electrode driver 500 receives the Y electrode driving control signal CONT3 from the controller 200 and applies a driving voltage to the Y electrodes Y1-Yn.

As shown in FIG. 2, in the sustain period, a voltage difference between the Y electrode and the X electrode alternately has a voltage Vs and a voltage −Vs. Then, sustain discharge is repeatedly generated a predetermined number of times in the light emitting cells.

For operation of the sustain period, according to the exemplary embodiment, a sustain discharge circuit is formed in one driver among the sustain electrode driver 400 and scan electrode driver 500. That is, the sustain discharge is generated between the X electrode and Y electrode using one sustain discharge circuit. Therefore, the sustain discharge circuits need not be formed in the sustain electrode driver 400 and the scan electrode driver 500, respectively.

FIG. 3 is a drawing showing a sustain discharge circuit 600 according to an exemplary embodiment. Switches used in FIG. 3 are illustrated as n-channel transistors. However, a field effect transistor (FET) having a body diode may be used for the switches used in FIG. 3, and other switches that can perform a similar function may be used for the switches used in FIG. 3. Further, FIG. 3 shows a capacitive component formed by a single Y electrode and a single X electrode as a panel capacitor Cp.

As shown in FIG. 3, the sustain discharge circuit 600 includes a DC/DC converter 510. FIG. 3 shows an LLC resonance converter as the DC/DC converter 510, and another converter may be used for the DC/DC converter 510.

The DC/DC converter 510 includes a switching circuit unit 512, and a transformer TX. The switching circuit unit 512 includes two output terminals, transistors Q1 and Q2, and a resonance capacitor Cr.

A drain of the transistor Q1 is connected to a first terminal (+) of a DC source for supplying a DC voltage Vin, a source of the transistor Q1 is connected to a drain of the transistor Q2, and a source of the transistor Q2 is connected to a second terminal (−) of the DC source. The transistors Q1 and Q2 are respectively turned on/off by the control signals S1 and S2 transmitted from the controller (200 in FIG. 2). At this time, since the control signal S1 has an opposite phase to the control signal S2, one of the transistors Q1 and Q2 is turned on and the other is turned off.

A first terminal of the resonance capacitor Cr is connected to a contact point between the source of the transistor Q1 and the drain of the transistor Q2. At this time, a first output terminal of the switching circuit unit 512 is formed by a second terminal of the resonance capacitor Cr, and a second output terminal of the switching circuit unit 512 is formed by the source of the transistor Q2.

The transformer TX includes a primary coil L1, and a secondary coil L2. A first terminal of the primary coil L1 is connected to the first output terminal of the switching circuit unit 512, and a second terminal of the primary coil L1 is connected to the second output terminal of the switching circuit unit 512. Further, a first terminal of the secondary coil L2 and second terminal of the secondary coil L2 are connected between a first terminal of the panel capacitor Cp and a second terminal of the panel capacitor Cp.

The transformer TX has a leakage inductance and a magnetizing inductance. FIG. 3 shows the leakage inductance and the magnetizing inductance as a serial inductor Ls and a parallel inductor Lm, respectively.

A first terminal of the serial inductor Ls is connected to the second terminal of the resonance capacitor Cr, and a second terminal of the serial inductor Ls is connected to the first terminal of the primary coil L1. The parallel inductor Lm is connected between the second terminal of the serial inductor Ls and the second output terminal of the switching circuit unit 512. Such DC/DC converter 510 generates a resonance by the resonance capacitor Cr and the serial inductor Ls corresponding to the leakage inductance. Alternatively, an inductor may be directly connected between the resonance capacitor Cr and the first terminal of the primary coil L1.

A voltage Vcp of two terminals of the panel capacitor Cp may be determined by turn ratio between the primary coil L1 and the secondary coil L2 as in Equation 1.

Vcp=±(Ns/Np*V1) (Equation 1)

Here, Ns denotes a number of turns of the secondary coil L2, Np denotes a number of turns of the primary coil L1, and Ns/Np denotes the turn ratio of the transformer TX. Further, V1 is an input voltage. Such V1 is a voltage between the first and second terminals of the switching circuit unit 512.

According to the exemplary embodiment, the turn ratio of the transformer TX is set so that the voltage Vcp becomes a voltage ±Vs. Further, the controller 200 transmits the control signals S1 and S2 to the gates of the transistor Q1 and Q2 in the sustain period.

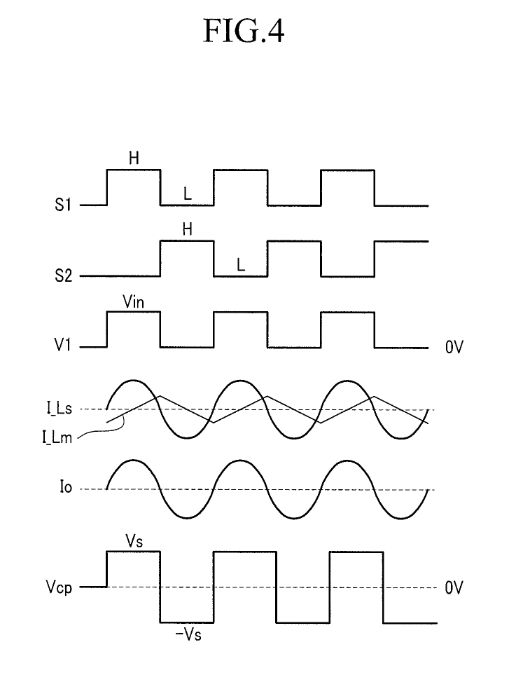

FIG. 4 is a drawing showing a waveform for describing the operation of the sustain discharge circuit shown FIG. 3.

As shown in FIG. 4, when the controller 200 outputs the control signal S1 of a high level H to the gate of the transistor Q1 and outputs the control signal S2 of a low level L to the gate of the transistor Q2, the transistor Q1 is turned on and the transistor Q2 is turned off. Then, the resonance may occur between the resonance capacitor Cr and the serial inductor Ls. Further, a current I_Ls that flows to the serial inductor Ls may be increased as a sine wave form by the resonance, and the current I_Ls flows through the primary coil L1 of the transformer TX. At this time, a current I_Lm that flows to the parallel inductor Lm may be gradually increased in a linear fashion. As a result, the voltage V1 becomes the voltage Vin. Further, the voltage V1 may be induced to the secondary coil L2 of the transformer TX, and the resonance may occur between the secondary coil L2 and the panel capacitor Cp. Then, a resonance current Io flows from the Y electrode to the X electrode and the voltage Vcp becomes the voltage Vs by Equation 1.

Next, when the controller 200 outputs the control signal S1 of a low level L to the gate of the transistor Q1 and outputs the control signal S2 of a high level L to the gate of the transistor Q2, the transistor Q1 is turned off and the transistor Q2 is turned on. Then, the resonance may occur between the resonance capacitor Cr and the serial inductor Ls. Further, since the direction of the current I_Ls becomes opposite by the resonance, the current I_Ls may be decreased as a sine wave form and the current I_Lm may be gradually decreased in a linear fashion. As a result, the voltage V1 becomes 0V. Further, the voltage V1 may be induced to the secondary coil L2 of the transformer TX, and the resonance may occur between the secondary coil L2 and the panel capacitor Cp. Then, a resonance current Io flows from the X electrode to the Y electrode and the voltage Vcp becomes the voltage −Vs by Equation 1.

When an operation for turning on and turning off the transistors Q1 and Q2 is repeated, the voltage V1 becomes a square wave voltage for repeating the voltage V1 and 0V. That is, the voltage Vcp alternately becomes a voltage Vs and a voltage −Vs during the sustain period, and thus, the sustain discharge is generated in the emitting cells.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display comprising:
a panel capacitor formed by first and second electrodes to perform a sustain discharge;
a driver to drive the panel capacitor so that a voltage between a first terminal of the panel capacitor and a second terminal of the panel capacitor alternately has a positive first voltage and a negative second voltage,
wherein the driver comprises
a switching circuit unit including at least one switch element connected to an input source to supply an input voltage, a first output terminal, and a second output terminal, so that a voltage between the first output terminal and the second output terminal becomes a square wave voltage using the at least one switch element; and
a transformer including a primary coil having a first terminal and a second terminal connected to the first and second output terminals of the switching circuit unit, respectively, and a secondary coil directly connected between the first and second terminals of the panel capacitor.

2. The plasma display of claim 1, wherein the switching circuit unit further comprises:
a first transistor connected to the input source; and
a second transistor connected between the first transistor and a ground source.

3. The plasma display of claim 2, further comprising a controller that outputs control signals for turning on and turning off the first and second transistors to control terminals of the first and second transistors in the sustain period, respectively,
wherein the controller alternately turns on the first and second transistors.

4. The plasma display of claim 2, wherein the switching circuit unit further comprises a capacitor connected between a contact point between the first and second transistors of the switching circuit unit and a first terminal of the primary coil of the transformer.

5. The plasma display of claim 4, wherein the transformer further comprises an inductor connected to the capacitor of the switching circuit unit and the first terminal of the primary coil of the transformer.

6. A driving apparatus of a plasma display including a panel capacitor formed by a first electrode and a second electrode for sustain discharging in a sustain period, the driving apparatus comprising:
a switching circuit unit including at least one switch element connected to an input source for supplying an input voltage, a first output terminal, and a second output terminal, so that a voltage between the first output terminal and the second output terminal becomes a square wave voltage using the at least one switch element; and
a transformer including a primary coil having a first terminal and a second terminal connected to the first and second output terminals of the switching circuit unit, respectively, and a secondary coil connected between first and second terminals of the panel capacitor,
wherein the transformer forms a current path from a first terminal of the panel capacitor to a second terminal of the panel capacitor and a current path from the second terminal of the panel capacitor to the first terminal of the panel capacitor in response to the turning on and turning off of the at least one switch.

7. The driving apparatus of claim 6, wherein the secondary coil is directly connected between first and second terminals of the panel capacitor.

8. The driving apparatus of claim 6, wherein the switching circuit unit further comprises:
a first transistor connected to a first terminal of the input source; and
a second transistor connected between the first transistor and a second terminal of the input source.

9. The driving apparatus of claim 8, further comprising a controller that outputs a first control signal to turn on and turn off the first transistor to a first control terminal of the first transistor, and outputs a second control signal to turn on and turn off the second transistor to a second control terminal of the second transistor, in the sustain period,
wherein a type of the first transistor is the same type as the second transistor and a phase of the first control signal is opposite to a phase of the second control signal.

10. The driving apparatus of claim 8, wherein the switching circuit unit further comprises a capacitor connected between a contact point between the first and second transistors and the primary coil.

11. The driving apparatus of claim 10, wherein the transformer further comprises an inductor connected between the capacitor of the switching circuit unit and the primary coil of the transformer.

12. The driving apparatus of claim 6, wherein the driving apparatus drives the panel capacitor so that a voltage between first and second terminals of the panel capacitor alternately has a positive first voltage and a negative second voltage.

13. The driving apparatus of claim 12, wherein an absolute value of the first voltage is equal to an absolute value of the second voltage.
